(19) United States
(12) Patent Application Publication
(10) Pub. No.: US 2019/0336852 A1
(43) Pub. Date: Nov. 7, 2019

(54) DEVICE WITH PRESSURE-SENSITIVE DISPLAY AND METHOD OF USING SUCH DEVICE

(71) Applicant: ALCATEL LUCENT, Nozay (FR)

(72) Inventors: Meng GAO, Shanghai (CN); Leitao ZHI, Shanghai (CN); Ning LI, Shanghai (CN); Dacheng YIN, Shanghai (CN); Kang LI, Shanghai (CN)

(21) Appl. No.: 16/473,840

(22) PCT Filed: Dec. 26, 2016
(86) PCT No.: PCT/CN2016/112092

§ 371 Date: Jun. 26, 2019

(51) Int. Cl. A63F 13/2145; A63F 13/92; G06F 3/0484; G06F 3/0354

(52) U.S. Cl. CPC A63F 13/2145; A63F 13/92; A63F 13/812; G06F 3/03547; G06F 3/04847

(57) ABSTRACT

A device comprises a pressure-sensitive touchscreen and is configured to be used for playing games wherein a game parameter for performing an action in the game is calculated as a function of pressure exerted by a user on the pressure-sensitive touchscreen, a maximum value of the pressure that can be exerted by the user on the screen and a maximum value of the game parameter.

The present disclosure relates to devices having a pressure-sensitive display suitable for playing video games and methods of using such devices.

### BACKGROUND

In the recent years, modern electronic devices such as mobile phones, tablets and some portable (also known as laptop) computers are equipped with touchscreens which allow a user to interact with the device by touching the display of the same instead of using input interfaces such as keyboards, joysticks or the like. Some of such touchscreens are capable of sensing the pressure, e.g. of a user's finger, on the screen. Based on such sensing, the device may accordingly take further actions such as for example processing or changing a specific function or application.

One of the popular usages of modern touchscreen devices is playing video games. In such cases, the device does not need a separate input interface such as a keyboard, a joystick, a console, etc. Instead a virtual interface (e.g. virtual joystick or action button) is shown at some location on the display to allow the user interaction with the device.

### SUMMARY

Some embodiments feature a device comprising a pressure-sensitive touchscreen, wherein the device is configured to:
initiate an application for playing a game by a user in response to a triggering effect prompted by the user;
select a game parameter in response to an input received from the user on the touchscreen;
select an input interface associated with said game parameter in response to an input received from the user on the touchscreen;
obtain a first pressure value in response to a maximum pressure exerted by the user on said pressure-sensitive touchscreen;
obtain a second pressure value in response to a further pressure exerted by the user on said pressure-sensitive touchscreen, said further pressure being less than said maximum pressure value;
calculate a value of a game parameter associated with the further pressure value; and
apply said calculated value of the game parameter to an action performed in the game and shown on the touchscreen;
   wherein said calculation is based on said first pressure value, said second pressure value and a maximum value associated to said game parameter.

According to some specific embodiments, the game parameter is associated to an action in the game in response to a command input into the device by the user, using an input interface,

According to some specific embodiments, said command is input into the device upon exerting a pressure on the touchscreen by a user's finger, a stylus stick or a stylus pen.

According to some specific embodiments, said input interface associated with said game parameter is a virtual joystick or a virtual button shown on the touchscreen.

According to some specific embodiments, the first pressure value and the second pressure value are stored in the device or stored in a further device different from the device.

According to some specific embodiments, the maximum value of the game parameter is predetermined and stored in a memory element prior to initiating the game.

According to some specific embodiments, the maximum value of the game parameter is determined by the user and stored in a memory element. According to some specific embodiments, the device is configured to perform an action in the game corresponding to the calculated second pressure value.

According to some specific embodiments, said calculation is based on the following formula:

GP=GPₘₐₓ*(P/Pₘₐₓ)

where GP is a game parameter, GPₘₐₓ is a maximum value of the game parameter, P is a pressure exerted by the user and Pₘₐₓ is a maximum amount of pressure stored with respect to the game.

Some embodiments feature a method of using a device having a pressure-sensitive touchscreen, the method comprising:
initiating an application for playing a game by a user in response to a triggering effect prompted by the user;
selecting a game parameter in response to an input received from the user on the touchscreen;
selecting an input interface associated with said game parameter in response to an input received from the user on the touchscreen;
obtaining a first pressure value in response to a maximum pressure exerted by the user on said pressure-sensitive touchscreen;
obtaining a second pressure value in response to a further pressure exerted by the user on said pressure-sensitive touchscreen, said further pressure being less than said maximum pressure value;
calculating a value of a game parameter associated with the further pressure value; and
applying said calculated value of the game parameter to an action performed in the game and shown on the touchscreen;
   wherein said calculation is based on said first pressure value, said second pressure value and a maximum value associated to said game parameter.

According to some specific embodiments, the method further comprises storing the first pressure value and the second pressure value in the device or in a further device different from the device.

According to some specific embodiments, the method further comprises storing in a memory element the maximum value of the game parameter determined by the user.

According to some specific embodiments, the method further comprises performing an action in the game corresponding to the calculated second pressure value.

These and further features and advantages of the present invention are described in more detail, for the purpose of illustration and not limitation, in the following description as well as in the claims with the aid of the accompanying drawings.

### BRIEF DESCRIPTION OF THE DRAWINGS

FIG. 1 is an exemplary schematic representation of a device having a pressure-sensitive touchscreen.

FIG. 2 is a flow diagram representing a method of using a device having a pressure-sensitive touchscreen according to some embodiments.

FIGS. 3a and 3b illustrate different instances of an action run on a device having a pressure-sensitive touchscreen according to some embodiments.

### DETAILED DESCRIPTION

FIG. 1 shows a schematic representation of a device 1 having a pressure-sensitive touchscreen 110 (herein also referred to as screen). The device 100 may be for example a mobile station such as a cell phone, a tablet or a laptop. The device 100 maybe configured to establish wireless connection with another device or with a wireless network, or communicate with other devices or networks using wireline connections.

The device 100 may be configured to be used for playing games such as video games. In such a case, the screen 110 may be configured to show a number of playing options or icons. For example, the device 100 of FIG. 1 shows a virtual joystick 120 and a number of virtual buttons 130. In a typical video game representation, the joystick 120 maybe used to move an object, e.g. a virtual object in the video game, in various directions as shown by arrows on the joystick 120. Likewise, the virtual buttons 130 may be used to trigger an action, for example shooting a ball in the video game.

Known devices having a pressure-sensitive touchscreen typically allow the user to exert different levels of pressure on the screen 110 to cause the device to perform different actions in different fashions. For example, pressing a virtual button 130 using a first pressure may cause the game to perform an action at a first parameter rate, e.g. shooting a ball with low strength; whereas pressing the same virtual button using a second pressure, higher than the first pressure, may cause the game to perform the same action at a second parameter rate, e.g. shooting the ball with a higher strength.

However, to the knowledge of the inventors, such known devices with pressure-sensitive touchscreens are only configured to adjust the parameter rate based on a predetermined and non-adjustable configuration of the touchscreen. Therefore, such devices will typically always respond in the same manner in response to the same level of pressure.

One drawback associated with this problem is that users with lower physical force, such as young children and teenagers, who typically have less strength in their hands and fingers, as compared to adults, would not be able perform actions at the same parameter rate as an adult. For example, in the case of shooting a ball as mentioned above, a child would typically not be able to shoot the ball as hard as an adult would be able to shoot the same ball in the same game. This may make the game experience less attractive for the child.

Embodiments of the present disclosure address the above problem. In particular, the solution proposed herein provides the possibility of adjusting, by the user, the range of values of a parameter in a game so as to accommodate such range of values to the need, capability or desire of the user.

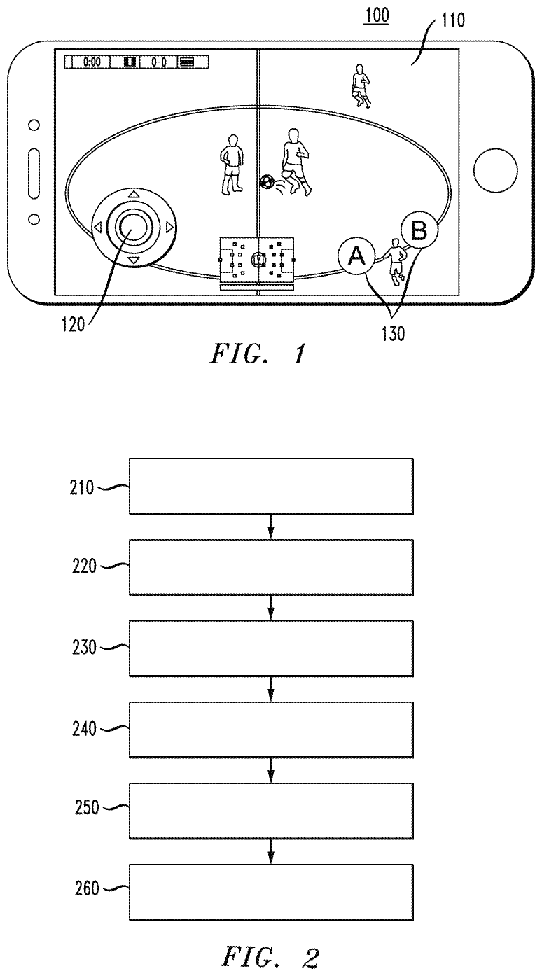

FIG. 2 illustrates an example of a method 200 of using a device having a pressure-sensitive touchscreen according to some embodiments.

At step 210, the device 100 having a pressure-sensitive touchscreen is activated for starting a video game. This may be performed in any known manner of starting a video game in a suitable electronic device. In some embodiments such activation may be obtained by an action of the user, such as touching a corresponding application on the screen or pressing a physical button on the device. Examples of games may be sports games such as football, basketball, tennis, car racing, and the like.

Starting a game may prompt, among other things, a number of options for the user to choose from. One such option may be the selection, at step 220, of a game parameter.

Herein the term game parameter is to be understood to relate to an action to be performed in the game in response to a command input into the device by the user. In the particular case of pressure-sensitive touchscreens, such command may be input into the device upon exerting a pressure on the screen by a user's finger, a stylus stick or a stylus pen.

Some non-limiting examples of game parameters may be values representing a distance, a speed, a height or a power associated with an action. For example, in a game where the player is throwing an object or shooting a ball, the distance covered by the throwing or the shooting may be regarded as a game parameter. Similarly, where a player is running or driving a car, the speed of such running or driving may be a game parameter. The height that a player can jump or the force with which a player can exercise a blow or an impact on an object are other non-limiting examples of game parameters.

Once the game parameter is selected, at step 230, an input interface associated with such game parameter may be selected. For example, a virtual joystick may be chosen as an input interface associated with running and a virtual button may be selected as an input associated with shooting a ball.

At step 240, for each selected game parameter and associated input interface, a sample of the maximum pressure that the user is able to exert on the screen is obtained and stored. To this end, the touchscreen may show interactive messages prompting the user to follow a number of steps to input and register such the maximum pressure he or she can exert on the screen. The registered maximum pressure is stored in the device and is used for calculating subsequent game parameters as the user plays the game.

Preferably, the maximum pressure may be stored in profile configuration files for each game and each user. The profile configuration files may be created as desired. For example, upon creating a profile configuration file for the first time, the user may input the maximum pressure value and associate such value to a specific name representing the user. Therefore, at any time after creation of such profile, when the user launches the game, he or she can select the stored profile. In this manner, maximum values registered for a child may be different from values registered for an adult who can typically press harder than the child.

At this stage the device is prepared to start the game with the specific maximum pressure value stored for the user.

In some embodiments, for each game parameter, e.g. power, distance, height, speed, etc., the game may already have maximum values associated to such game parameter and stored in the device's memory elements (or in other suitable locations). For example, in a particular game, the maximum value related to speed Sₘₐₓ may have an assigned virtual speed value, similar values may be assigned to the maximum distance Dₘₐₓ associated to an action (e.g. throwing a ball), maximum height Hₘₐₓ associated to an action (e.g. jumping), and so on. Values related to Sₘₐₓ, Dₘₐₓ and Hₘₐₓ may be predetermined and stored in a memory element.

In some embodiments, the maximum value of the game parameters, e.g. power, distance, height, speed, etc. may be determined by the user and input and temporarily stored into the device. This would allow for the possibility of determining values such as Sₘₐₓ, Dₘₐₓ and Hₘₐₓ based on the skills and the experience of the user. Thus for example the maximum values of game parameters for a person with little gaming experience and/or skill may be smaller than the maximum values determined for a more experienced and skilled user.

As the game starts the user may press the touchscreen in occasions where he or she needs to perform a specific action, e.g. jumping. At step 250, the device may calculate the value of the game parameter associated with such action as described below.

The pressure exerted by the user may in occasions be the maximum pressure as identified above. If this is the case, the action is performed at its maximum level of the associated game parameter, e.g. Hₘₐₓ in case of jumping.

However, in many occasions the pressure exerted by the user may not be the maximum and thus the device may calculate a proportional value for the action which would correspond to the level of pressure exerted by the user on the touchscreen. The proportional value for the particular action may be calculated based on the following formula:

GP=GPₘₐₓ*(P/Pₘₐₓ) (1)

where GP is a game parameter, GPₘₐₓ is the maximum value of the game parameter, P is the pressure exerted by the user while playing and Pₘₐₓ is the maximum amount of pressure stored in the device. Note that if GP is equal to GPₘₐₓ, then the P will equal Pₘₐₓ which is the scenario discussed above with respect to exerting maximum pressure by the user.

The above formula (1) clearly shows the proportionality of the effect of a game parameter with the amount of pressure exerted by the user. Such proportionality may provide a more realistic feeling of the game for the user as compared to known techniques in which proportionality may not be obtained.

Once the game parameter for a specific action is calculated, at step 260 the action is performed on the screen as a video effect which can be seen by the user.

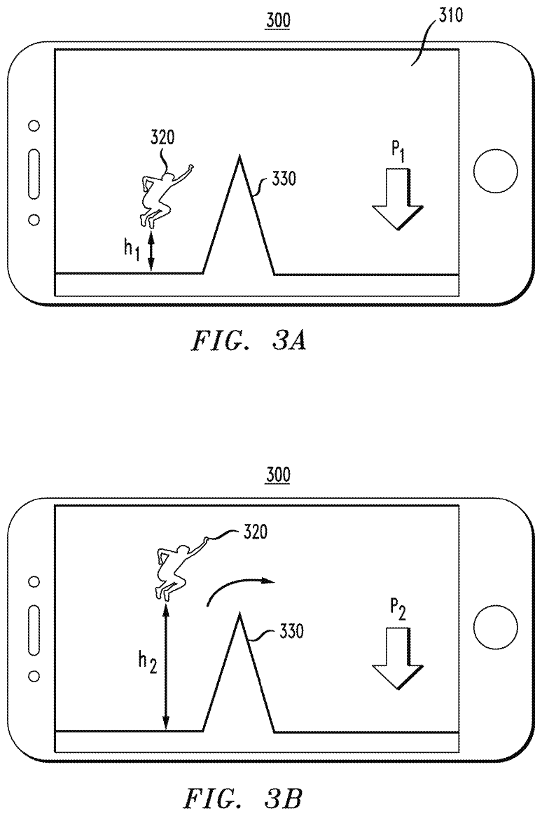

FIGS. 3a and 3b provide an example of two instances of a game parameter of a video game as shown on the screen of a cell phone 300 having a pressure-sensitive touchscreen 310.

Referring first to FIG. 3a, it is assumed that the video game has a game parameter related to jumping by a virtual object 320 over a virtual hurdle 330. It is further assumed that values related to maximum pressure Pₘₐₓ and maximum game parameter GPₘₐₓ are already stored in the device as described above.

In a first attempt, the user may press the touchscreen 310 with a first pressure level P₁. This will cause the device to calculate a first value of the height for the virtual object 320 to jump using the formula (1). The calculation of the height renders the first value h₁ and the effect is shown on the touchscreen 310 as represnted in FIG. 3a.

Assuming that h₁ is not a height sufficient for enabling the virtual object 320 to jump over the hurdle 330, the user may initiate a second attempt in which a stronger pressure P₂ is exerted on the touchscreen 310, as shown in FIG. 3b. This second pressure P₂ will cause the device to calculate a second value of the height for the virtual object 320 to jump using the formula (1). The calculation of the height renders the second value h₂ which is higher than h₁ (as the pressure P₂ is higher than pressure P₁). This second height of the jump may be enough for the virtual player 320 to be able to clear the hurdle 330, the effect of which is shown on the touchscreen 310 as represented in FIG. 3b.

As mentioned above, some examples of devices capable of embodying the proposed solution may be cell phones, tablets or laptops. However, the disclosure is not limited to the named devices and it may be applied to any other device which possess the suitability of embodying the solution proposed herein.

Likewise, while the device with a pressure-sensitive touchscreen maybe with the user (e.g. held in users hands), the storing of the maximum pressure values and/or the maximum game parameter values may be done at a remote location. This may be the case for example in situations where the game is played online. However, calculation of the game parameters as described above with reference to formula 1 is performed by the pressure-sensitive touchscreen device.

The various embodiments of the present invention may be combined as long as such combination is compatible and/or complimentary.

The method is implemented in a preferred embodiment through or together with a software process or software module including one or more software programs (computer programs).

The device proposed herein may use programmable elements that can be any kind of device which can be programmed including e.g. any kind of computer like a server or a personal computer, an FPGA, a processor, or the like, or any combination thereof, e.g. one processor and two FPGAs.

It is to be noted that the order of the steps of the method of the invention as described and recited in the corresponding claims is not limited to the order as presented and described and may vary without departing from the scope of the invention.

The storage elements could be any kind of data repository in any storage medium such as a CD or disk, e.g. USB memory stick or any kind of memory, e.g. at least one RAM or ROM, or the like, or any combination thereof, e.g. one ROM and two RAMs, or two disks, etc.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

1. A device comprising a pressure-sensitive touchscreen, wherein the device is configured to:
initiate an application for playing a game by a user in response to a triggering effect prompted by the user;
select a game parameter in response to an input received from the user on the pressure-sensitive touchscreen;
select an input interface associated with said game parameter in response to another input received from the user on the pressure-sensitive touchscreen;
obtain a first pressure value in response to a maximum pressure exerted by the user on the pressure-sensitive touchscreen;
obtain a second pressure value in response to a further pressure exerted by the user on the pressure-sensitive touchscreen, the further pressure being less than said maximum pressure;
calculate a value of the game parameter associated with the further pressure; and
apply the calculated value of the game parameter to an action performed in the game and shown on the pressure-sensitive touchscreen,
wherein the calculated value of the game parameter is based on the first pressure value, the second pressure value and a maximum value associated with the game parameter.

2. The device of claim 1, wherein the game parameter is associated with an action in the game in response to a command input into the device by the user using the input interface.

3. The device of claim 2, wherein the command is input into the device upon exerting a pressure on the input interface by a user's finger, a stylus stick or a stylus pen.

4. The device of claim 2, wherein the input interface associated with the game parameter is a virtual joystick or a virtual button shown on the pressure-sensitive touchscreen.

5. The device of claim 1, wherein, the first pressure value and the second pressure value are stored in the device or stored in a further device different from the device.

6. The device of claim 1, wherein the maximum value of the game parameter is predetermined and stored in a memory element prior to initiating the game.

7. The device of claim 1, wherein the maximum value of the game parameter is determined by the user and stored in a memory element.

8. The device of claim 1, wherein the device is configured to perform an action in the game corresponding to the obtained second pressure value.

9. The device of claim 1, wherein the calculated value of the game parameter is based on the formula:
GP=GPₘₐₓ*(P/Pₘₐₓ),
where GP is the game parameter, GPₘₐₓ is the maximum value of the game parameter, P is a pressure exerted by the user and Pₘₐₓ is a maximum amount of pressure stored with respect to the game.

10. A method of using a device having a pressure-sensitive touchscreen, the method comprising:
initiating an application for playing a game by a user in response to a triggering effect prompted by the user;
selecting a game parameter in response to an input received from the user on the pressure-sensitive touchscreen;
selecting an input interface associated with the game parameter in response to another input received from the user on the pressure-sensitive touchscreen;
obtaining a first pressure value in response to a maximum pressure exerted by the user on the pressure-sensitive touchscreen;
obtaining a second pressure value in response to a further pressure exerted by the user on the pressure-sensitive touchscreen, the further pressure being less than the maximum pressure;
calculating a value of the game parameter associated with the further pressure; and
applying the calculated value of the game parameter to an action performed in the game and shown on the pressure-sensitive touchscreen,
wherein the calculated value of the game parameter is based on the first pressure value, the second pressure value and a maximum value associated with the game parameter.

11. The method of claim 10, further comprising storing the first pressure value and the second pressure value in the device or in a further device different from the device.

12. The method of claim 10, further comprising storing in a memory element the maximum value of the game parameter determined by the user.

13. The method of claim 10, further comprising performing an action in the game corresponding to the obtained second pressure value.

14. The method of claim 10, wherein the game parameter is associated with an action in the game in response to a command input into the device by the user using the input interface.

15. The method of claim 14, wherein the command is input into the device by the user upon exerting a pressure on the input interface by a user's finger, a stylus stick or a stylus pen.

16. The method of claim 14, wherein the input interface associated with the game parameter is a virtual joystick or a virtual button shown on the pressure-sensitive touchscreen.

17. The method of claim 10, further comprising storing the maximum value of the game parameter in a memory element prior to initiating the game, wherein the maximum value of the game parameter is predetermined.

18. The method of claim 10, wherein calculating the value of the game parameter is based on the formula:
GP=GPₘₐₓ*(P/Pₘₐₓ),
where GP is the game parameter, GPₘₐₓ is the maximum value of the game parameter, P is a pressure exerted by the user and Pₘₐₓ is a maximum amount of pressure stored with respect to the game.
